(19) United States
(12) Patent Application Publication
(10) Pub. No.: US 2012/0002771 A1
(43) Pub. Date: Jan. 5, 2012

(54) RECEIVER, SEMICONDUCTOR DEVICE, AND SIGNAL TRANSMISSION METHOD

(75) Inventor: Yoshihiro Nakagawa, Tokyo (JP)

(73) Assignee: NEC CORPORATION, Tokyo (JP)

(21) Appl. No.: 13/254,735

(22) PCT Filed: Mar. 4, 2010
(86) PCT No.: PCT/JP2010/053561

§ 371 Date: Sep. 2, 2011

(30) Foreign Application Priority Data
Mar. 5, 2009 (JP) 2009-052711

(51) Int. Cl. H04L 7/00

(52) U.S. Cl. 375/354

(57) ABSTRACT

A receiver comprises: a reception coil through which flow a current of a polarity corresponding to data is allowed to flow by flowing a current through a transmission coil for every rising edge or falling edge of a clock signal relating to transmission of data, and generates a signal induced by means of electromagnetic induction by flowing the current through the transmission coil; a transition detection circuit which detects a level transition of a signal generated in the reception coil; and a clock recovery circuit which recovers the clock signal based on the detection result of the transition detection circuit.

### TECHNICAL FIELD

### Description of Related Application

This application is based upon and claims the benefit of the priority of Japanese patent application No. 2009-052711, filed on Mar. 5, 2009, the disclosure of which is incorporated herein in its entirety by reference thereto. This invention relates to a receiver, a semiconductor device, and a signal transmission method. In particular, it relates to a receiver, a semiconductor device, and a signal transmission executing a signal transmission by means of electromagnetic induction.

### BACKGROUND

Recently, as circuits embedded in a semiconductor device are highly integrated, a semiconductor device which integrates a plurality of semiconductor chips and realizes data transmission by means of electromagnetic induction between coils formed on each of semiconductor chips is proposed. In these semiconductor devices, a coil formed on one semiconductor chip generates a magnetic signal. And a signal proportional to a derivative value of the current signal provided to the transmission coil is induced in a coil formed on the other semiconductor chip. A noncontact signal transmission between the chips is executed by receiving the induced signal (see Patent Documents 1 to 4, and Non-Patent Documents 1 to 4).

### [Patent Document 1]

Japanese Patent Kokai Publication No. JP-A07-221260

### [Patent Document 2]

Japanese Patent Kokai Publication No. JP-A08-236696

### [Patent Document 3]

International Publication WO 2007/29435 A1 (pamphlet)

### [Patent Document 4]

U.S. Pat. No. 4,785,345

[Non-Patent Document 1]

### Noriyuki Miura, et al., “Analysis and Design of Transceiver Circuit and Inductor Layout for Inductive Inter-chip Wireless Superconnect”, IEEE 2004 Symposium on VLSI Circuits Digest of Technical Papers, pp. 246-249 (2004)

### [Non-Patent Document 2]

Hiroki Ishikuro, et al., “An Attachable Wireless Chip Access Interface for Arbitrary Data Rate Using Pulse-Based Inductive-Coupling through LSI Package”, IEEE International Solid-State Circuits Conference 2007 Digest of Technical Papers, pp360-361, 608 (2007)

### [Non-Patent Document 3]

Noriyuki Miura, et al., “A 1 Tb/s 3 W Inductive-Coupling Transceiver for Inter-Chip Clock and Data Link”, IEEE International Solid-State Circuits Conference 2006 Digest of Technical Papers, pp11-13 (2006)

### [Non-Patent Document 4]

Noriyuki Miura, et al., “An 11 G/s Inductive-Coupling Link with Burst Transmission”, IEEE International Solid-State Circuits Conference 2008 Digest of Technical Papers, pp298-299, 614 (2008)

### SUMMARY

The following analyses are given according to the present invention.

In related arts, transmission data is received by sampling a signal induced in a reception coil with the clock timing having a cycle. In this case, since a signal width induced in the reception coil is smaller than a cycle of the transmission data, the reception clock must be controlled with high accuracy. Therefore, in order to control the reception clock, a large control circuit must be needed, or more power consumption is caused.

For example, in Non-Patent Document 3, a clock signal, which is a signal controlling timing of current providing to the transmission coil, is also transmitted as in parallel with the transmission data so as to realize a reception clock with high accuracy. However, a pair of coils for clock transmission is needed other than that for data transmission, which causes both the occupying area and the power consumption to increase.

On the other hand, in Non-Patent Document 4, a reception clock signal is not needed by realizing an asynchronous signal reception. Therefore, the method enables low power consumption. However, since there are no clock signals synchronized to the received data, it is impossible to synchronize between the received data and other operational circuits or the like which use the reception data. Thus, another clock channel for synchronizing with the operational circuit is provided to recover the synchronous clock signal. Therefore, that causes both the occupying area and the power consumption to increase.

It is an object of the present invention to provide a receiver, a semiconductor device, and a signal transmission method in which the reception clock signal controlled with high accuracy is unnecessary and which consumes low power and occupies small area, upon executing noncontact signal transmission by means of electromagnetic induction.

### MEANS TO SOLVE THE PROBLEMS

In accordance with one aspect of the present invention, a receiver comprises: a reception coil through which a current of a polarity corresponding to data is allowed to flow by flowing a current through a transmission coil for every rising edge or falling edge of a clock signal relating to transmission of data, to generate a signal induced by means of electromagnetic induction by flowing the current through the transmission coil; a transition detection circuit which detects a level transition of a signal generated in the reception coil; and a clock recovery circuit which recovers the clock signal based on the detection result of the transition detection circuit.

In accordance with another aspect of the present invention, a signal transmission method comprises: flowing a current of a polarity corresponding to data to flow through a transmission coil for every rising edge or falling edge of a clock signal relating to transmission of data, and generate signal induced in a reception coil by means of electromagnetic induction by flowing the current through the transmission coil; detecting a level transition of a signal generated in the reception coil; and recovering the clock signal based on the detection result of the level transition.

According to the present invention, since it is possible to transmit a signal without setting a transmission channel dedicated to a clock or using a reception clock signal controlled with high accuracy, the reduction of occupying area and power consumption becomes possible.

### BRIEF DESCRIPTION OF THE DRAWINGS

FIG. 1 is a diagram showing a configuration of a transmitter in accordance with an exemplary embodiment of the present invention;

FIG. 2 is a circuit diagram showing a transmitter in accordance with an exemplary embodiment of the present invention;

FIG. 3 is a diagram showing a configuration of a receiver in accordance with an exemplary embodiment of the present invention;

FIG. 4 is a diagram showing a configuration of a clock recovery unit in accordance with a first exemplary embodiment of the present invention;

FIG. 5 is a circuit diagram showing a signal transition detector in accordance with the first exemplary embodiment of the present invention;

FIG. 6 is another circuit diagram showing a signal transition detector in accordance with the first exemplary embodiment of the present invention;

FIG. 7 is a circuit diagram showing a clock waveform shaper in accordance with the first exemplary embodiment of the present invention;

FIG. 8 is a timing chart illustrating a transmitter and a receiver in accordance with the first exemplary embodiment of the present invention;

FIG. 9 is a circuit diagram showing a signal transition detector in accordance with a second exemplary embodiment of the present invention;

FIG. 10 is another circuit diagram showing a signal transition detector in accordance with the second exemplary embodiment of the present invention;

FIG. 11 is a circuit diagram showing a hysteresis amplifier in accordance with the second exemplary embodiment of the present invention;

FIG. 12 is a timing chart illustrating a transmitter and a receiver in accordance with the second exemplary embodiment of the present invention;

FIG. 13 is a diagram showing a clock recovery unit in accordance with a third exemplary embodiment of the present invention;

FIG. 14 is a diagram showing a configuration of a semiconductor apparatus in accordance with an exemplary embodiment of the present invention;

FIG. 15 is a diagram showing a sectional view of a semiconductor apparatus in accordance with an exemplary embodiment of the present invention;

FIG. 16 is a diagram showing another configuration of a semiconductor apparatus in accordance with an exemplary embodiment of the present invention;

FIG. 17 is a diagram showing a further configuration of a semiconductor apparatus in accordance with an exemplary embodiment of the present invention; and

FIG. 18 is a diagram showing other configuration of a semiconductor apparatus in accordance with an exemplary embodiment of the present invention.

### PREFERRED MODES

A receiver in accordance with an exemplary embodiment of the present invention comprises: a reception coil through which a current of a polarity corresponding to data is allowed to flow by flowing a current through a transmission coil for every rising edge or falling edge of a clock signal relating to transmission of data, to generate a signal induced by means of electromagnetic induction by flowing the current through the transmission coil; a transition detection circuit which detects a level transition of a signal generated in the reception coil; and a clock recovery circuit which recovers the clock signal based on the detection result of the transition detection circuit.

The transition detection circuit may comprise: a discrimination circuit which discriminates a signal level induced in the reception coil with respect to a plurality of threshold values; and a logic operational circuit which calculates a detection result of the transition detection circuit by executing a logic operation among the discrimination results respectively corresponding to a plurality of threshold values.

The discrimination circuit may comprise: a first comparator which compares the signal level with a first threshold value; and a second comparator which compares the signal level with a second threshold value being lower than the first threshold value. If the signal level is not less than the first threshold value, or if the signal level is not more than the second threshold value, the logic operational circuit outputs a first logical value. Whereas, if the signal level is more than the second threshold value and is less than the first threshold value, the logic operational circuit outputs a second logical value.

The transition detection circuit may be a hysteresis circuit which receives a signal induced in the reception coil and operates based on two threshold values.

The clock recovery circuit may comprise: an integration circuit which integrates a signal representing the detection result of the transition detection circuit; and a buffer circuit which has a predetermined threshold value, and binarizes an output signal of the integration circuit.

The clock recovery circuit may comprise: a delay circuit which delays a detection result signal representing the detection result of the transition detection circuit; and an operational circuit determining whether or not the detection result signal and an output signal of the delay circuit are identical at logical level, and recovering the clock signal based on the determination result.

A signal delay amount of the delay circuit is preferably half width of signal portion in current waveform that flows in the transmission coil.

The clock recovery circuit may comprise an oscillator circuit and a phase frequency detection circuit; the phase frequency detection circuit may detect a phase and/or frequency difference between the detection result signal representing the detection result of the transition detection circuit and an oscillation signal of the oscillator circuit; and the oscillator circuit may output an oscillation signal whose oscillation frequency is varied corresponding to the difference to the phase frequency detection circuit, and also output as the recovered clock signal.

The receiver may comprise a circuit which recovers data from a signal induced in the reception coil based on the recovered clock signal.

The receiver in accordance with an exemplary embodiment of the present invention may have the following configuration in an outline.

(1) There is provided a signal transmission method for transmitting data using a transmission coil and a reception coil inductor-coupled (induction-coupled) to the transmission coil, wherein the method comprises: allowing a current to flow through a transmission coil for every rising edge or falling edge of a clock used for transmitting data; and capturing a signal induced in the reception coil by flowing the current through the transmission coil for every rising edge or falling edge of the clock to recover the received data and transmit the signal. In the signal transmission method, a receiver comprises: a transition detection circuit, which is connected to the reception coil, detects a signal transition induced in the reception coil; and a circuit generating a signal which always keeps the same phase difference as the signal detected in the transition detection circuit.

(2) A receiver, wherein a signal, which always keeps the same phase difference as a signal detected by a circuit detecting a signal transition induced in a reception coil, is a clock signal.

(3) A receiver comprising a transition discriminator connected to a reception coil, wherein the transition discriminator comprises: a discrimination circuit which discriminates a signal level induced in the reception coil against a plurality of threshold levels; and an operational circuit which is connected to the output of the discrimination circuit and operates a discrimination result, and the transition discriminator detects a signal transition induced in the reception coil.

(4) A receiver, wherein a plurality of threshold values are predetermined positive and/or negative threshold values.

(5) A receiver comprising: a determination unit connected to one end of a reception coil which compares with a predetermined positive threshold value; a determination unit connected to one end of the reception coil which compares with a predetermined negative threshold value; and an operational circuit operating a logical sum between the outputs of the determination units.

(6) A receiver comprising: a discrimination circuit connected to one end of the reception coil which discriminates against a plurality of threshold values and outputs a discrimination result depending on an output result of the circuit before a predetermined period; a delay circuit connected to the output result of the discrimination circuit; and an operational circuit operating an exclusive logical sum between the output result of the discrimination circuit and the output of the delay circuit.

(7) A receiver, wherein a signal delay amount of a delay circuit is half of a signal width provided to a transmission coil.

(8) A receiver comprising a wave shaper circuit which is connected to an output of a transition detection circuit, and always keeps the same phase difference as the output result of the transition detection circuit, and is capable of changing the width of the output signal.

(9) A receiver, wherein a wave shaper circuit comprises at least one of inverter circuits having various threshold values.

(10) A receiver comprising: an oscillator which is capable of controlling a phase or a frequency of an output signal or both; and a phase/frequency detection circuit which is capable of detecting a phase or frequency difference between the output of the oscillator and the output of the transition detection circuit or both, and outputs a control signal of the oscillator so as to make the phase or the frequency difference or both small.

(11) A receiver comprising a circuit recovering a transmission signal from a signal induced in a reception coil using a signal which always keeps the same phase difference as the transmission clock.

Furthermore, a semiconductor device including the above-mentioned receiver may be configured.

According to the present invention, upon executing noncontact signal transmission through electromagnetic induction, a signal transmission method or system is used in which the timing of current added to the transmission coil is a cycle determined regardless of the data stream of the transmitted signal. And a transition of a signal induced in the reception coil is detected using a transition detection circuit (a signal transition detector), and it is possible to recover the clock signal synchronized to the transmission signal by using the detected signal transition timing. For this reason, at least one of a reduction of occupying area of the transmitter, a reduction of power consumption needed for transmission/reception, and an extension (enlarging) of signal transmission distance can be realized.

At the receiver, a signal may be received at the same time as the recovery of the clock signal which is synchronized to the transmission signal. Furthermore, the recovered clock signal may be used as a synchronous signal for the signal arithmetic (processing) unit of the semiconductor device equipped with the receiver.

The exemplary embodiments will be described in detail below with reference to the drawings.

### First Exemplary Embodiment

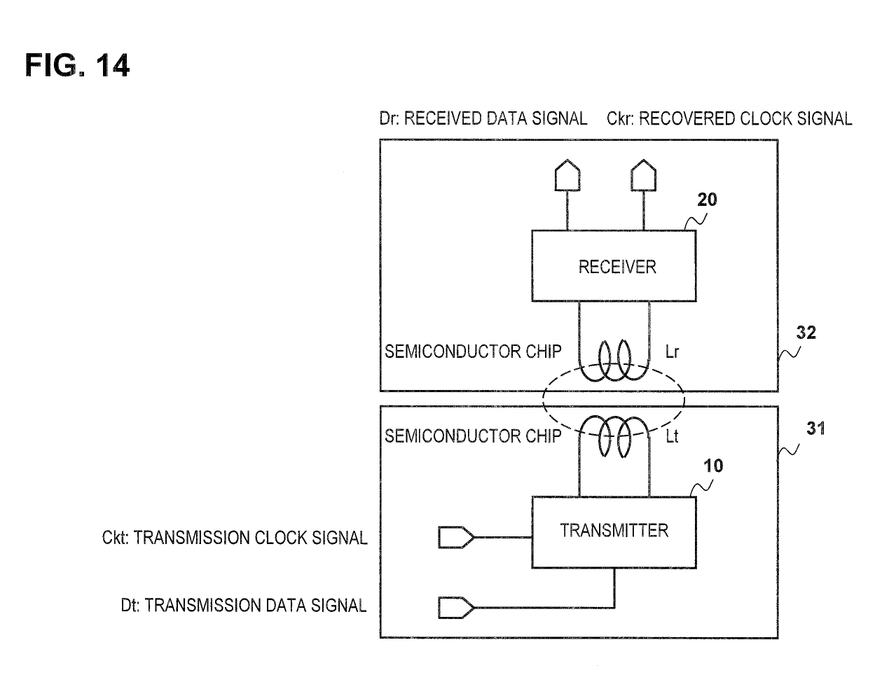

With reference to FIG. 14, a configuration of a semiconductor device in accordance with the present exemplary embodiment will be described. With reference to FIG. 14, semiconductor chips 31, 32, which execute noncontact signal transmission by means of electromagnetic induction, are arranged so that a reception coil Lr and a transmission coil Lt are opposing each other. In the semiconductor chip 31, the transmission coil Lt is connected to a transmitter 10 which receives transmission data signal Dt and transmission clock signal Ckt.

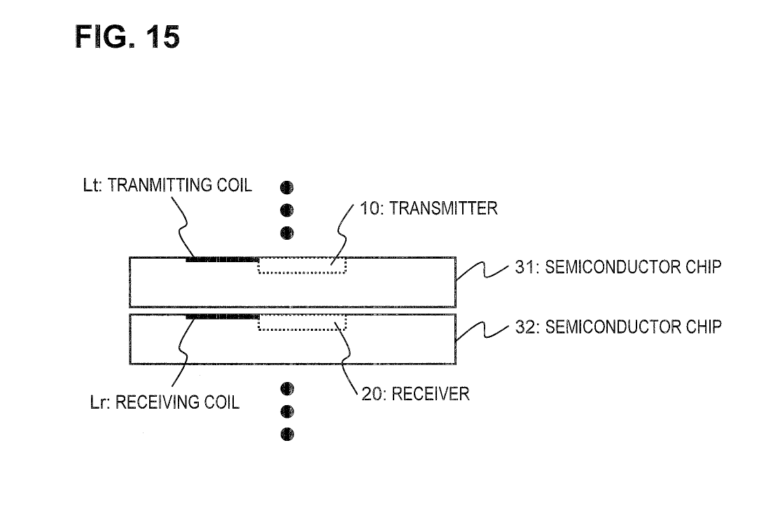

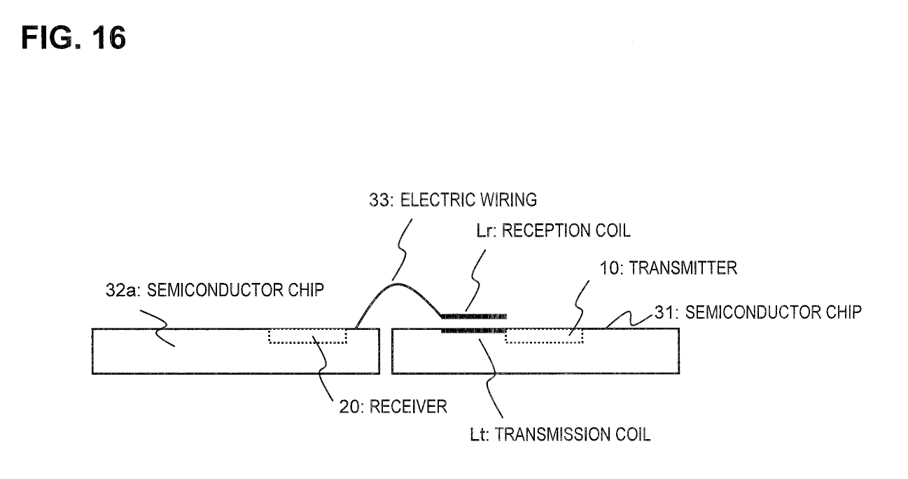

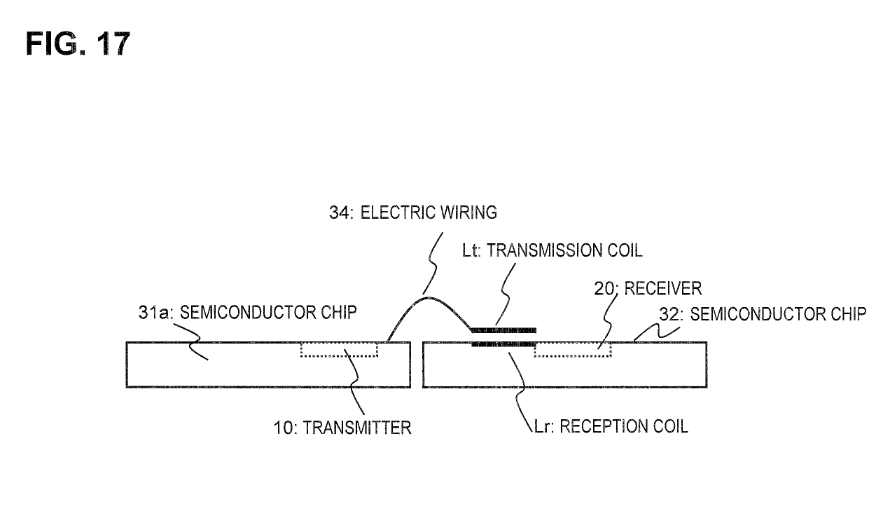

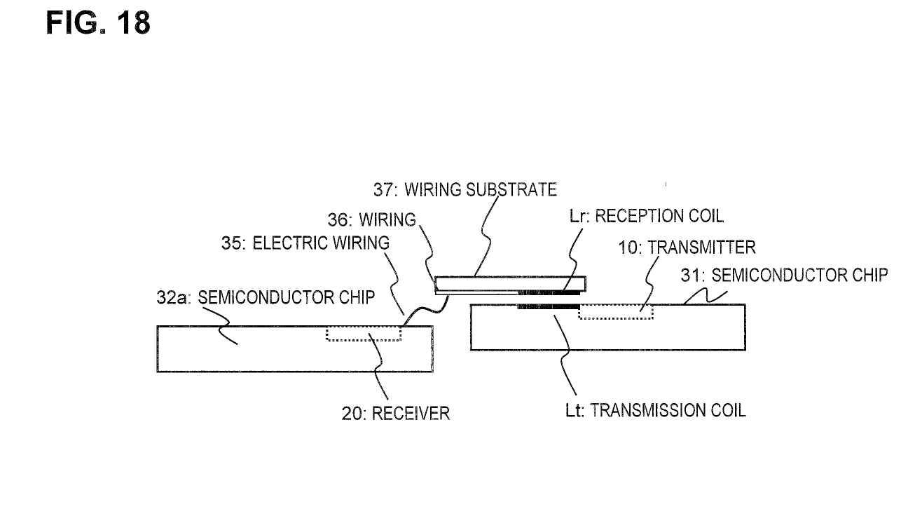

FIG. 15 is a sectional view of the semiconductor device shown in the FIG. 14. An example of FIG. 15 illustrates a case where the semiconductor chip 31 includes the transmission coil Lt and the transmitter 10, and the semiconductor chip 32 includes the reception coil Lr and the receiver 20. However, a semiconductor device in accordance with the present invention is not limited to this configuration. As shown in FIG. 16, the semiconductor device may include: the transmission coil Lt, the transmitter 10, and the reception coil Lr on the semiconductor chip 31; and the receiver 20 on the semiconductor chip 32a. As shown in FIG. 17, the semiconductor device may include: the transmitter 10 on the semiconductor chip 31a; the transmission coil Lt, the reception coil Lr, and receiver 20 on the semiconductor chip 32. Furthermore, as shown in FIG. 18, it is not necessary that the reception coil Lr is included on the semiconductor chip 31 or 32a. For example, at least one of the two coils may be included on a wiring substrate 37 that is different from the semiconductor chip 31, and transmitter 10 or receiver 20 which is formed on the semiconductor chip 31 or 32a is electrically connected to the transmission coil Lt or the reception coil Lr, so that a signal is transmitted by means of electromagnetic induction between the transmission coil Lt and the reception coil Lr which are opposing each other. In an example of FIG. 18, the reception coil Lr is arranged on the wiring substrate (or board) 37, and is connected to the receiver 20 on the semiconductor chip 32a by a wiring 36 and an electric wiring 35.

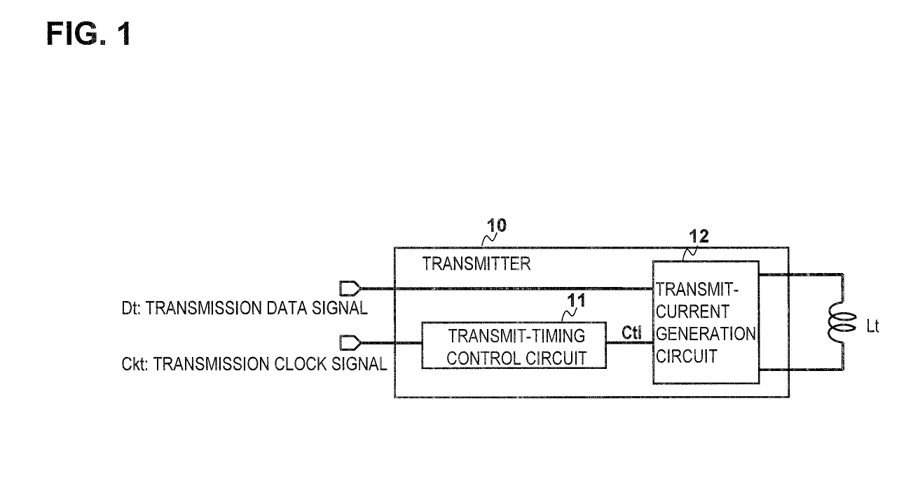

FIG. 1 is a block diagram of a transmission side apparatus of the present invention. The transmission side apparatus includes the transmitter 10, and the transmission coil Lt.

A transmission clock signal Ckt is supplied to the transmitter 10 in addition to a transmission data signal Dt. The transmitter 10 includes a transmit-timing control circuit 11 and a transmit-current generation circuit 12. The transmit-timing control circuit 11 controls a timing of a current flowing through the transmission coil Lt using the transmission clock signal Ckt. On the other hand, the transmit-current generation circuit 12 generates a transmission current using control signal Ct1 outputted from the transmit-timing control circuit 11, and the transmission data signal Dt. A feature of the present transmitter resides in that the output of the transmit-current generation circuit 12 is generated from the transmission data signal Dt and the transmission clock signal Ckt, and that a current of polarity corresponding to data to the transmission coil is allowed to flow at every rising edge or falling edge of the transmission clock signal Ckt, although a conventional apparatus flows a current through the transmission coil only at transition points of data. Namely, a current flowing through the transmission coil Lt is generated by not only at the transition points of the transmission data signal Dt but those of the control signal Ct1 by the transmit-timing control circuit 11, that is, transition points of the transmission clock signal Ckt, wherein the direction of the current is varied in accordance to on the transmission data signal Dt.

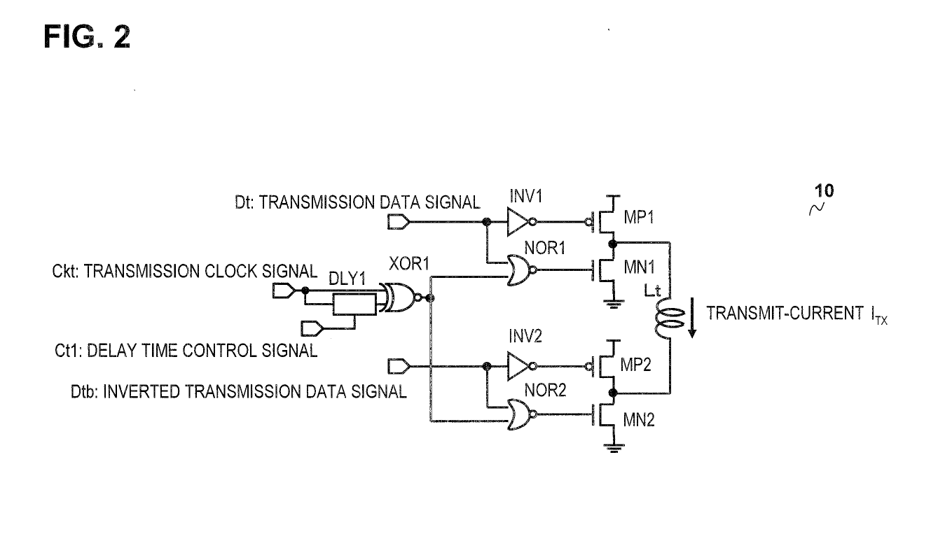

FIG. 2 illustrates an example of a detailed transmission circuit of a transmitter in accordance with the present invention. A transmission data signal Dt, a transmission data inverted signal Dtb that is an inverted signal of Dt, and a transmission clock signal Ckt are provided to the transmitter 10. The transmission clock signal Ckt is provided to the delay circuit DLY1 and one input end of the negative exclusive logical sum circuit XOR1. The delay circuit DLY1 controls a delay time of the transmission clock signal Ckt using delay time control signal Ct1, and outputs a delayed transmission clock signal Ckt to the other input end of the negative exclusive logical sum circuit XOR1. The negative exclusive logical sum circuit XOR1 outputs minute pulses, which have a cycle equivalent to the transmission clock frequency to one input end of the negative logical sum circuit NOR1 and one input end of the negative logical sum circuit NOR2. The negative logical sum circuit NOR1 receives the transmission data signal Dt at the other input end, and its output end is connected to a gate of the NMOS transistor MN1. The negative logical sum circuit NOR2 receives the transmission data inverted signal Dtb at the other input end, and its output end is connected to agate of the NMOS transistor MN2. The inverter circuit INV1 inverts the transmission data signal Dt, and outputs to a gate of the PMOS transistor MP1. The inverter circuit INV2 inverts the transmission data inverted signal Dtb, and outputs to a gate of the PMOS transistor MP2. A source of the NMOS transistor MN1 is connected to ground, and its drain is connected to one end of the transmission coil Lt and a drain of the PMOS transistor MP1. A source of the NMOS transistor MN2 is connected to ground, and its drain is connected to the other end of the transmission coil Lt and a drain of the PMOS transistor MP2. Sources of the PMOS transistors MP1, MP2 are connected to the power supply.

When the transmission data signal Dt is 1 (high level), the PMOS transistor MP1 is ON; since the transmission data inverted signal Dtb is 0 (low level), the PMOS transistor MP2 is OFF. At this time, the MNOS transistor MN1 is OFF regardless of a polarity of the minute pulse (the output of the negative exclusive logical sum circuit XOR1). Whereas, when the minute pulse is 0, the NMOS transistor MN2 is ON; when the minute pulse is 1, the NMOS transistor MN2 is OFF. Therefore, only when the minute pulse is 0, a positive current I_{TX} flows through the transmission coil in the direction from the PMOS transistor MP1 to the NMOS transistor MN2. Here, a current direction in the transmission coil is assumed to be positive in a case where the current flows in the direction from the transmission data side to the transmission data inverted side (direction of the arrow). On the contrary, when the minute pulse is 1, since only the PMOS transistor MP1 is ON and the NMOS transistor MN2 is OFF, a current does not flow in the transmission coil Lt.

On the other hand, when the transmission data signal Dt is 0, since the PMOS transistor MP1 is OFF and the inverted transmission signal Dtb is 1, the PMOS transistor MP2 is ON. At this time, the NMOS transistor MN2 is OFF regardless of a polarity of the minute pulse. As for the NMOS transistor MN1, when the minute pulse is 0, the MN1 is ON; whereas when the minute pulse is 1, the MN1 is OFF. Therefore, only when the minute pulse is 0, a negative current I_{TX} flows to the transmission coil Lt in the direction from the PMOS transistor MP2 to the NMOS transistor MN1.

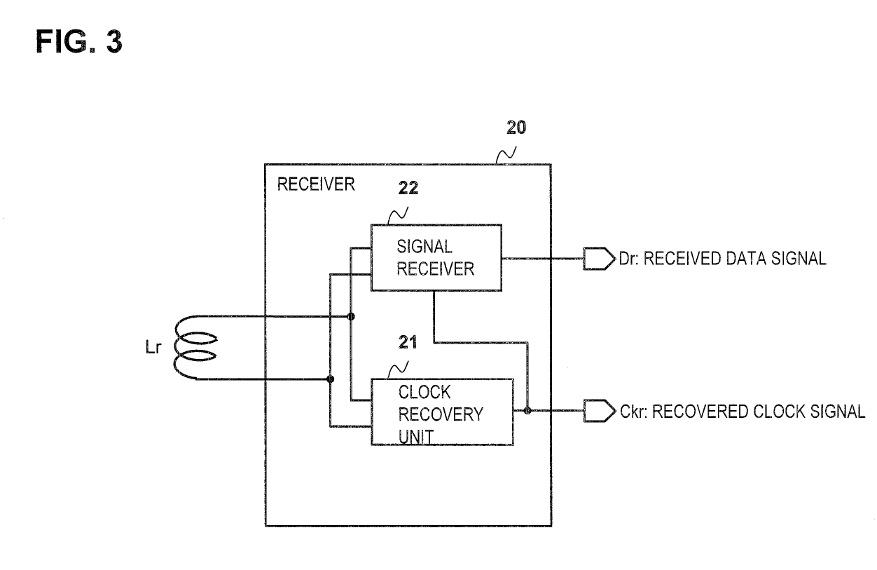

As shown in FIG. 15, since the transmission coil Lt and the reception coil Lr are arranged opposing each other, a signal is induced in the reception coil due to electromagnetic induction. As shown in FIG. 3, the receiver 20 connected to the reception coil Lr includes clock recovery unit 21, and signal receiver 22.

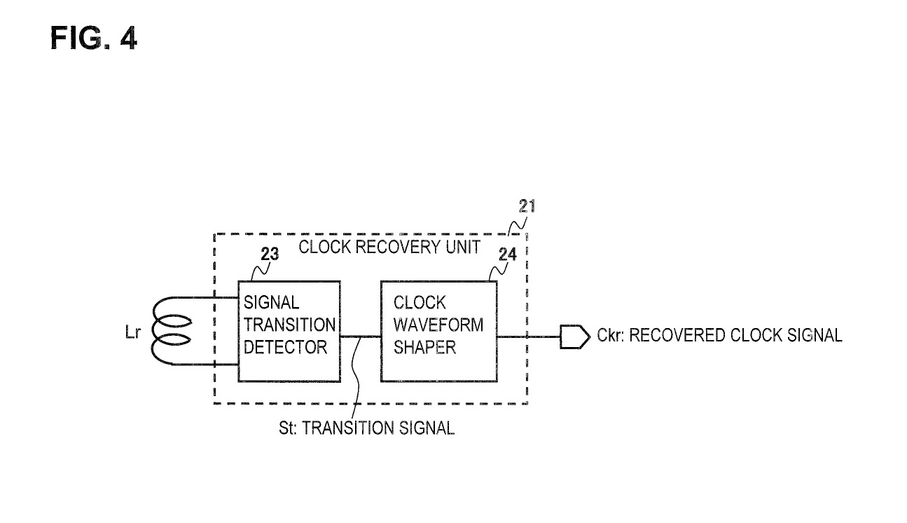

As shown in FIG. 4, the clock recovery unit 21 includes a signal transition detector 23 (corresponding to the transition detection circuit), and a clock waveform shaper 24 (corresponding to the clock recovery circuit), and outputs a recovered clock signal Ckr, which is synchronized to the transmission clock signal Ckt and always keeps the same phase difference as the Ckt, from a signal induced in the reception coil Lr. The recovered clock signal Ckr may be used in a signal processing after that, or may be provided to the signal receiver 22 and used to output received data signal Dr.

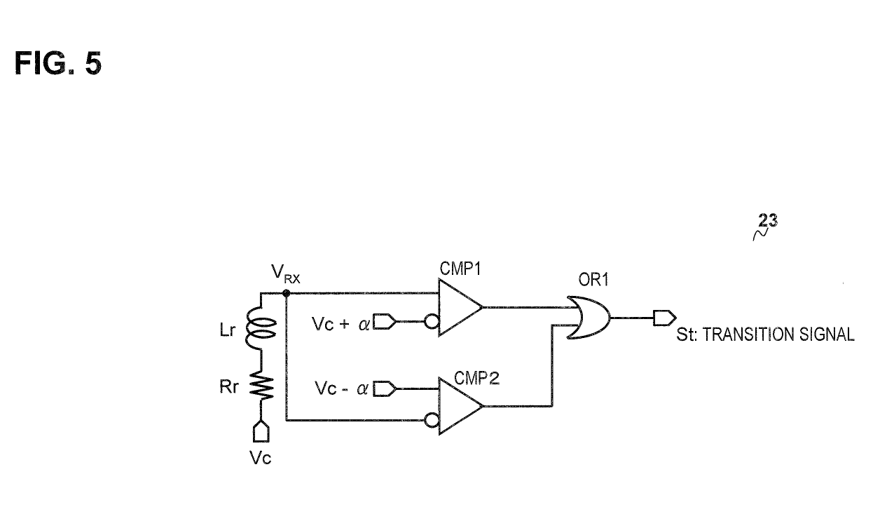

Next, the signal transition detector 23 will be described. FIG. 5 shows an example of a circuit diagram of the signal transition detector. The signal transition detector 23 includes two comparators CMP1, CMP2 which are connected to one end of the reception coil Lr, and a logical sum circuit OR1 which operates a logical sum between outputs of the comparators CMP1, CMP2. The comparator CMP1 receives a signal (Vc+α) which is by α larger than a common mode voltage Vc of the reception coil Lr at the other input terminal not connected to the reception coil Lr. The voltage source being Vc-α is connected to the comparator CMP2. The logical sum circuit OR1 operates the following logic operation for a voltage induced in the reception coil Lr so as to detect a signal transition in the reception coil Lr and output transition signal St.

### if Vᵣₓ≧Vc+α or Vᵣₓ≦Vc−α, St=1

### if Vc−α<Vᵣₓ<Vc+α, St=0

Here, an example, in which the reception coil Lr is directly connected to the signal transition detector 23, is described. However, it is unnecessary that the reception coil Lr is directly connected to the signal transition detector 23, and even if a circuit such as an amplifier is inserted between the reception coil Lr and the signal transition detector 23, the effect of the present invention is not distinguished.

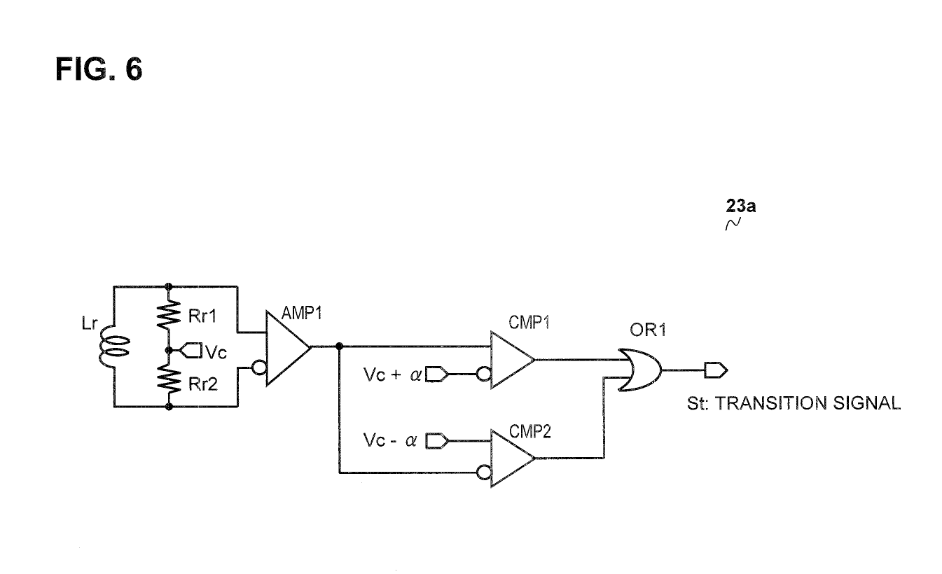

FIG. 6 illustrates a circuit diagram of signal transition detector 23a in a case where amplifier with differential inputs AMP1 are connected to input terminals of both ends of the reception coil Lr. Thus, not only a single configuration as shown in FIG. 5 but a circuit having a differential configuration as shown in FIG. 6 may be used.

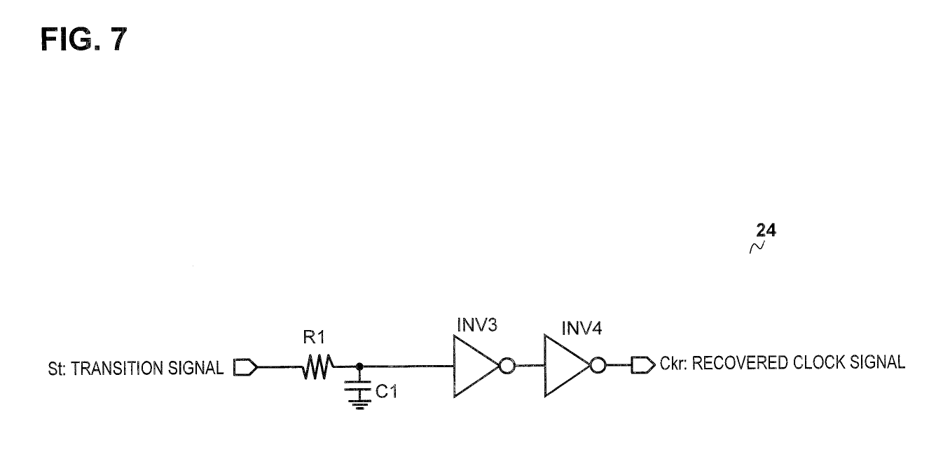

Next, the clock waveform shaper 24 will be described. FIG. 7 illustrates an example of a circuit diagram of the clock waveform shaper 24. The transition signal St has a pulse width nearly equal to a period in which current signal provided to the transmission coil Lt varies. Therefore, the recovered clock signal Ckr is obtained by transforming the waveform using the clock waveform shaper 24 so as to have a desired signal width. Here, as an example of the clock waveform shaper 24, as shown in FIG. 7, the transition signal St is realized by passing through an integral circuit which is formed of resistor element R1 and capacitor element C1, and combining two inverter circuits INV3, INV4 having certain threshold value.

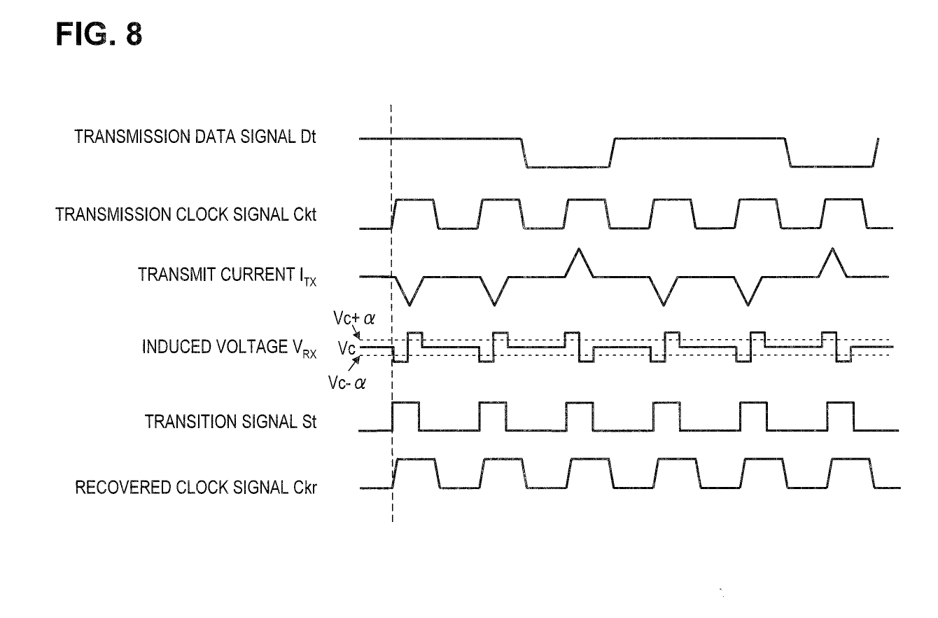

FIG. 8 is a timing waveform chart illustrating an operation of the present exemplary embodiment. FIG. 8 illustrates each of waveforms of transmission data signal Dt, transmission clock signal Ckt for transmitting the transmission data signal Dt, transmit-current I_{TX} provided to the transmission coil Lt, induction voltage V_{RX} induced in the reception coil, transition signal St which is an output of the transition signal detector 23, and recovered clock signal Ckr which is waveform-shaped by the clock waveform shaper 24.

As shown in FIG. 8, while transmitting signals, the transmit-current I_{TX}, which is synchronized to the transmission clock signal Ckt and has a polarity corresponding to the transmission data signal Dt, is supplied to the transmission coil Lt. Thereupon, the induction voltage V_{RX} is induced in the reception coil Lr by means of electromagnetic induction. At the time, the receiver 20 including the signal transition detector 23 connected to the reception coil Lr monitors the state of the reception coil Lr to detect signal transition. Since the transition signal St, which is an output of the signal transition detector 23, is synchronized to the current signal I_{TX} of the transmission Lt, the transition signal St always keeps the same phase difference as the transmission clock signal Ckt. Thereafter, the transmission signal St is waveform-shaped by the clock waveform shaper 24, so that the recovered clock signal Ckr, which always keeps the same phase difference as the transmission clock signal Ckt, is obtained.

The signal receiver 22 may receive a signal using the recovered clock signal Ckt obtained in this way. Even if a phase or a frequency of the transmission clock signal Ckt is varied due to a power fluctuation of the transmitter 10 or the like, since the recovered clock signal CKr always keeps the same phase difference as the transmission signal Ckt as mentioned above, it becomes possible to receive the signal without error.

The received signal which is inputted in time series may be converted to a parallel signal using the recovered clock signal Ckr obtained by the present invention, and the parallel signal may be used for signal processing or the like.

In order to reduce the signal transmission error in the conventional technique, it is necessary to increase size of the transmission/reception coil, keep short the transmission distance, require a power in transmitting/receiving, or provide a clock adjustment mechanism with high accuracy. However, according to the present invention, since the recovered clock signal is generated by detecting a level transition of a signal generated by the reception coil, it becomes possible to reduce the occupying area and lower power consumption.

### Second Exemplary Embodiment

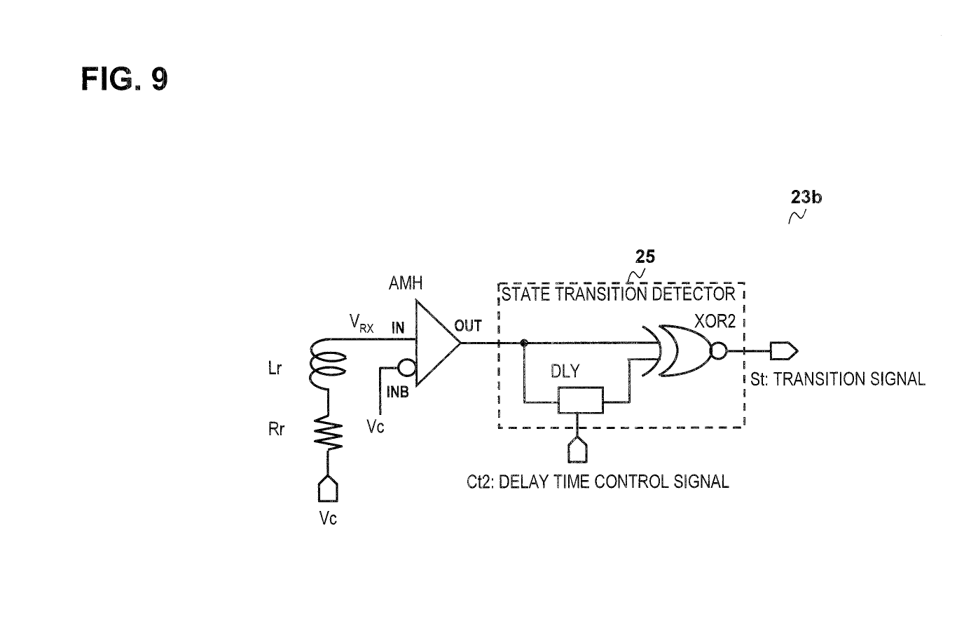

FIG. 9 is a diagram showing a configuration of a signal transition detector in accordance with a second exemplary embodiment of the present invention. In the first exemplary embodiment, a transition of a signal induced in the reception coil is detected by means of two comparators and a logical sum circuit. In contrast, in the second exemplary embodiment, signal transition detector 23b includes a hysteresis amplifier AMH, and a state transition detector 25. The state transition detector 25 includes a delay device DLY, and a negative exclusive logical sum circuit XOR2 which operates an exclusive logical sum between an output of the hysteresis amplifier AMH and an output of the delay device DLY. A signal delay amount is set in the delay device DLY using the delay time control signal Ct2.

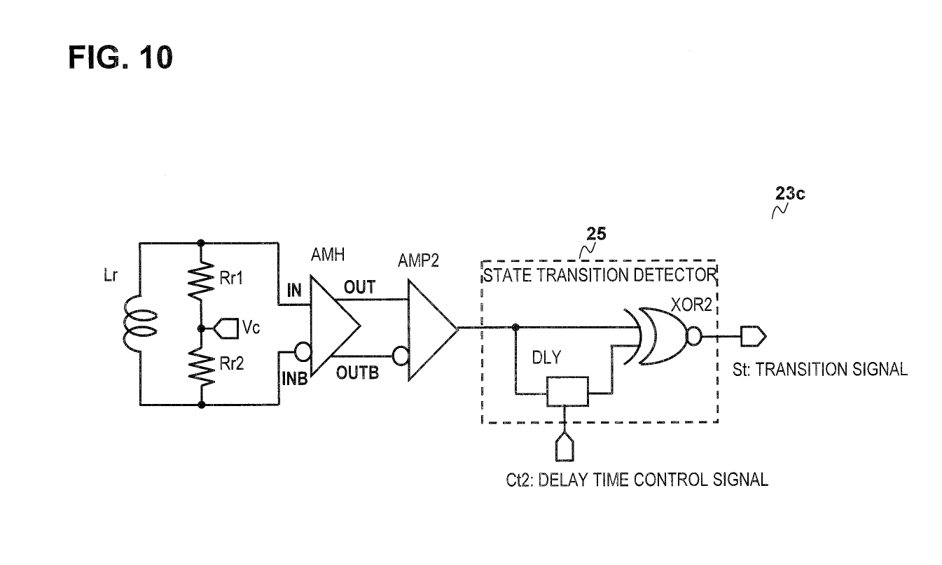

FIG. 10 illustrates a circuit diagram of signal transition detector unit 23c in which the hysteresis amplifier AMH connected to both (input) ends of the reception coil Lr, and amplifier with differential input AMP2 which amplifies an output of the hysteresis amplifier AMH are inserted. In this manner, not only a single configuration as shown in FIG. 9, but a circuit having a differential configuration as shown in FIG. 10 may be used.

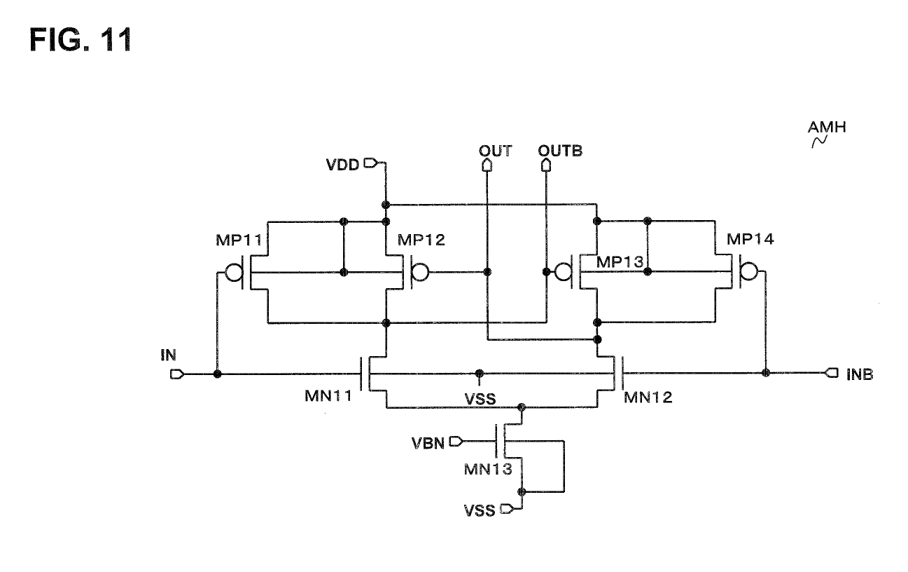

FIG. 11 is an example of a circuit diagram showing a configuration of the hysteresis amplifier AMH. The hysteresis amplifier AMH includes NMOS transistors MN11 to MN13, and PMOS transistors MP11 to MP14. A gate of the NMOS transistor MN11 is connected to input IN, and a source of the NMOS transistor MN11 is connected to a source of the NMOS transistor MN12 and a drain of the NMOS transistor MN13. Bias voltage VBN is provided to a gate of the NMOS transistor MN13, and a source of the NMOS transistor MN13 is connected to power supply VSS. A gate of the PMOS transistor MP11 is supplied with an input signal IN, and a drain of the PMOS transistor MP11 is connected to a drain of the PMOS transistor MP12, a drain of the NMOS transistor MN11, and an output terminal OUTB. A gate of the PMOS transistor MP14 is connected an input terminal INB, and a drain of the PMOS transistor MP14 is connected to a drain of the PMOS transistor MP13, a drain of the NMOS transistor MN12, and an output terminal OUT. Sources of the transistors MP11 to MP14 are connected to a power supply terminal VDD.

The hysteresis amplifier with such a configuration has the following characteristics.

In a case where V_{Rx}≧Vc+α, if the previous output state is 1, OUT=the state being held; if the previous output state is 0, OUT=1.
In a case where V_{rX}≦Vc−α, if the previous output state is 1, OUT=0; if the previous output state is 0, OUT=the state being held.
In a case where Vc−α<V_{rX}<Vc+α, OUT=the state being held.

Meanwhile, the α defining the hysteresis width is determined based on the size ratio of the PMOS transistors MP11, MP14 and the PMOS transistors MP12, MP13.

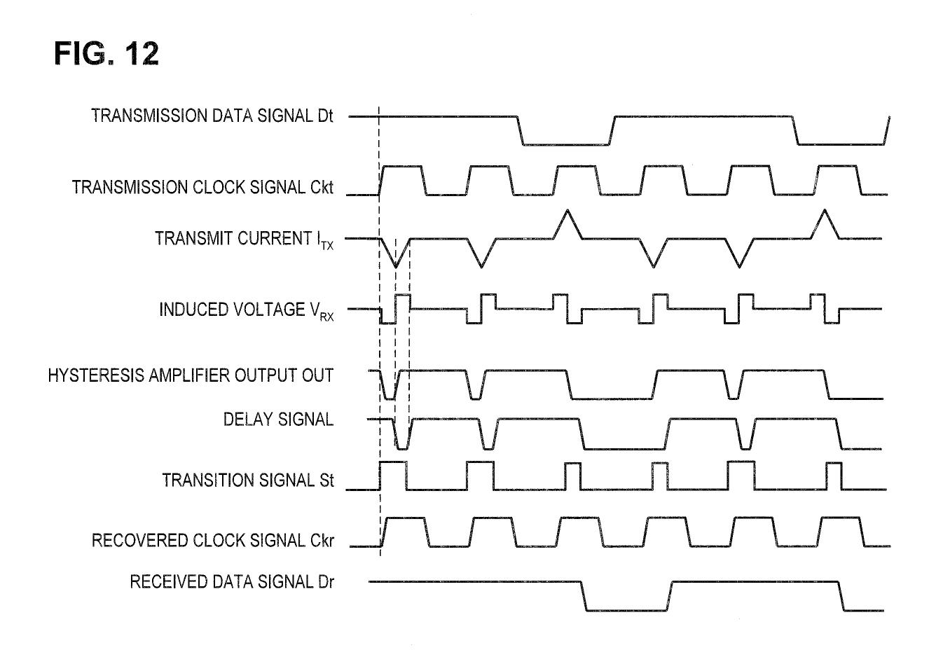

FIG. 12 is a timing waveform chart showing an operation of a signal transition detector in accordance with the second exemplary embodiment of the present invention. As shown in FIG. 12, the induction voltage V_{RX} induced in the reception coil Lr is amplified as an output of the hysteresis amplifier OUT by the hysteresis amplifier AMH connected to the reception coil Lr. The above-mentioned output of hysteresis amplifier OUT is provided to the delay device DLY to obtain a delayed signal which is delayed by certain period. Exclusive logical sum circuit XOR2 operates an exclusive logical sum between the output of the hysteresis amplifier OUT and the delayed signal. As shown in FIG. 12, the exclusive logical sum circuit XOR2 outputs the transition signal St by responding only if a signal is induced in the reception coil Lr. At this time, the signal delay amount by the delay device DLY is preferably about half width of the transmission waveform. If the delay amount becomes too small or too large, notches are caused in the transition signal St, which possibly become a cause of error operation.

If the above-mentioned transition detectors 23b, 23c are used, the transition signal St, which always keeps the same phase difference as the current signal provided to the transmission coil Lr, can be obtained. The recovery clock signal Ckr, which always keeps the same phase difference as the transmission clock signal Ckt, can be outputted by providing the transition signal St to the above-mentioned clock waveform shaper 24.

### Third Exemplary Embodiment

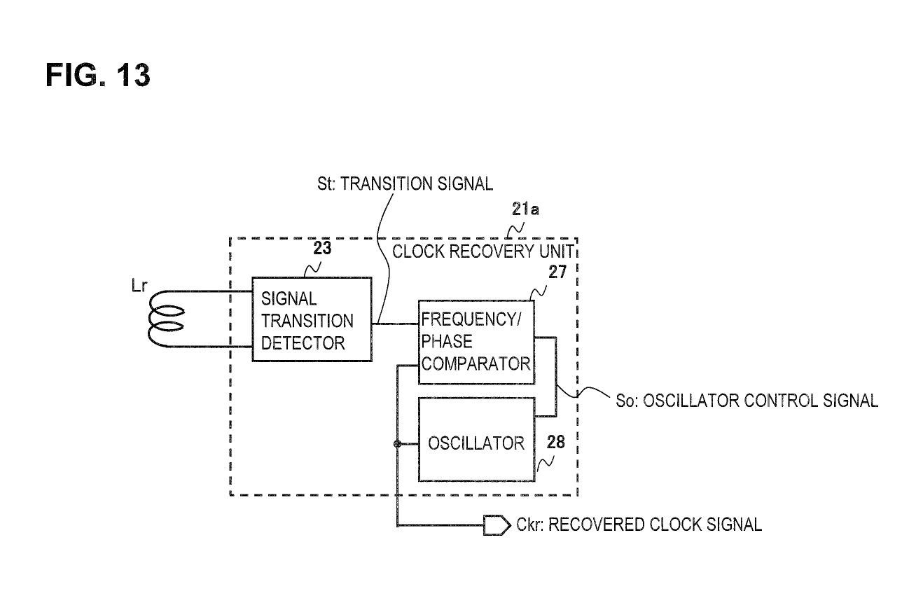

FIG. 13 is a diagram showing a configuration of a clock recovery unit in accordance with a third exemplary embodiment of the present invention. Clock recovery unit 21a includes a signal transition detector 23 which is connected to the reception coil Lr, an oscillator 28, and a frequency/phase comparator 27 which is connected to the output of the signal transition detector 23 and the output of the oscillator 28, and compares the output signal of the signal transition detector 23 and the output signal of the oscillator 28 with respect to frequency and phase. The output of the frequency/phase comparator 27 is used to control the oscillator 28. And The output of the frequency/phase comparator 27 controls the oscillator 28 so as to cancel differences of the frequency and phase between the output of the signal transition detector unit 23 and the output of the oscillator 28. According to such a clock recovery unit 21a, a clock recovery signal Ckr, which always keeps the same phase difference as the transmission clock signal Ckt, is obtained as an output of the oscillator 28.

According to the above-mentioned the first to the third exemplary embodiments, not using the other transmission device for transmitting the clock signal, the recovery clock signal Ckr, which always keeps the same phase difference as the transmission clock signal Ckt, can be obtained. Therefore, any one of or all of a reduction of the occupying area of the transmission/reception coil, a reduction of power needed for transmission/reception, and an extension of the signal transmission distance become possible.

The entire disclosure of the above mentioned Patent Documents and Non-Patent Documents are incorporated herein by reference thereto. The exemplary embodiments and examples may include variations and modifications without departing the gist and scope of the present invention as disclosed herein and claimed as appended herewith, and furthermore based on the fundamental technical gist. It should be noted that any combination and/or selection of the disclosed elements may fall within the claims of the present invention. That is, it should be noted that the present invention of course includes various variations and modifications that could be made by those skilled in the art according to the overall disclosures including claims and technical gist.

1. A receiver comprising:
a reception coil through which flows a current of a polarity corresponding to data is allowed to flow by flowing a current through a transmission coil for every rising edge or falling edge of a clock signal relating to transmission of data, to generate a signal induced by means of electromagnetic induction by flowing the current through said transmission coil;
a transition detection circuit which detects a level transition of a signal generated in said reception coil; and
a clock recovery circuit which recovers the clock signal based on the detection result of said transition detection circuit.

2. The receiver according to claim 1, said transition detection circuit comprising:
a discrimination circuit which discriminates a signal level induced in said reception coil with respect to a plurality of threshold values; and
a logic operational circuit which calculates a detection result of the transition detection circuit by executing a logic operation among the discrimination results respectively corresponding to said plurality of threshold values.

3. The receiver according to claim 2, wherein said discrimination circuit comprises:
a first comparator which compares said signal level with a first threshold value; and
a second comparator which compares said signal level with a second threshold value being lower than said first threshold value,
wherein if said signal level is not less than said first threshold value, or if said signal level is not more than said second threshold value, said logic operational circuit outputs a first logical value;
if said signal level is more than said second threshold value and is less than said first threshold value, said logic operational circuit outputs a second logical value.

4. The receiver according to claim 1, wherein said transition detection circuit is a hysteresis circuit which receives a signal induced in said reception coil and operates based on two threshold values.

5. The receiver according to claim 1, wherein said clock recovery circuit comprises:
an integration circuit which integrates a signal representing the detection result of said transition detection circuit; and
a buffer circuit which has a predetermined threshold value, and binarizes an output signal of said integration circuit.

6. The receiver according to claim 1, wherein said clock recovery circuit comprises:
a delay circuit which delays a detection result signal representing the detection result of said transition detection circuit; and
an operational circuit determining whether or not said detection result signal and an output signal of said delay circuit are identical at logical level, and recovering said clock signal based on the determination result.

7. The receiver according to claim 6, wherein a signal delay amount of said delay circuit is half width of a signal portion in current waveform that flows in said transmission coil.

8. The receiver according to claim 1, wherein said clock recovery circuit comprises an oscillator circuit and a phase frequency detection circuit, wherein
said phase frequency detection circuit detects a phase and/or frequency difference between a detection result signal representing the detection result of said transition detection circuit and an oscillation signal of said oscillator circuit;
said oscillator circuit outputs an oscillation signal whose oscillation frequency is varied corresponding to said difference, to said phase frequency detection circuit, and also outputs as said recovered clock signal.

9. The receiver according to claim 1, comprising a circuit which recovers data from a signal induced in said reception coil based on said recovered clock signal.

10. A semiconductor device, comprising the receiver according to claim 1.

11. A method for transmitting signal, comprising:
allowing a current of a polarity corresponding to data to flow through a transmission coil for every rising edge or falling edge of a clock signal relating to transmission of data, to generate a signal induced in a reception coil by means of electromagnetic induction by flowing the current through said transmission coil;
detecting a level transition of a signal generated in said reception coil; and
recovering said clock signal based on the detection result of said level transition.
